(19) United States
(12) Patent Application Publication
(10) Pub. No.: US 2015/0207909 A1
(43) Pub. Date: Jul. 23, 2015

(54) TABLET HOLDING SYSTEM

(71) Applicant: Philip C. Haugaard, Tegna (CH)

(72) Inventors: Johnny B. Nielsen, Roskilde (DK); Peter Morch, Hornbaek (DK); Andreas Haugaard, Humlebaek (DK)

(21) Appl. No.: 14/412,451

(22) PCT Filed: Jul. 5, 2013
(86) PCT No.: PCT/EP2013/064329

§ 371 Date: Jan. 1, 2015

(30) Foreign Application Priority Data
Jul. 5, 2012 (DK) PA 2012 70400

(51) Int. Cl. H04M 1/04

(52) U.S. Cl. CPC H04M 1/04

(57) ABSTRACT

A tablet holding system includes a mounting fixture and a housing. The housing has a back plate, holding elements arranged along the periphery of the back plate, and a locking mechanism. The housing is mountable onto the mounting fixture to support the housing in desired positions. The mounting fixture has a cylindrical portion. The tablet holding system has a connection element that connects the housing to the mounting fixture. The connection element has a fastening portion that is insertable into the cylindrical portion of the mounting fixture and fastenable to the inside of the cylindrical portion of the mounting fixture. The housing is fastened to the connection element with a screw through the back plate in a direction from the tablet facing side of the back plate towards the fastening portion of the connection element and which is hidden by a tablet when a tablet is locked in the housing.

The current invention relates to a tablet holding system comprising a housing suitable for holding a tablet, said housing comprising a back plate which is suitable for supporting a tablet, holding elements arranged along the periphery of the back plate which are suitable for holding onto the side edges of a tablet and a locking mechanism with a key, said locking mechanism arranged to lock the holding elements so that it is not possible to remove a tablet held in the housing when the locking mechanism is activated, a mounting fixture onto which the housing is mountable to support the housing in a desired position or positions, said mounting fixture comprising a cylindrical portion.

By tablet holding system, is meant a system which holds a tablet in a desired position. In certain cases, the system can be arranged to allow the tablets position to be changed, for example by providing a fitting which can pivot thereby allowing the tablet to pivot or by arranging the mounting fixture to be displaceable thereby allowing the tablet to change its location. The position in which the tablet is held is dependent on the intended use of the tablet holding system.

By tablet is meant an electronic tablet, such as an iPad™ or similar. Tablets are usually rectangular in shape and have a diagonal dimension between 17 cm and 35 cm. They are usually of reduced thickness, usually less than 3 cm, less than 2 cm or less than 1.5 cm. However, the system of the current invention could also be used with larger tablets or even flatscreen TVs or monitors.

It should also be noted that the term cylindrical portion should not be limited to cylinders with circular cross sections, but could include any other form as well, for example square and rectangular. Furthermore it should be noted that the cylindrical portion could be bent into a curved shape if desired without falling outside of the scope of protection.

### DESCRIPTION OF RELATED ART

Many different tablet holding systems are available in the prior art. One non-limiting example use of such a tablet holding system is when a tablet is used as a display at an exhibition or in a shop. This is sometimes called a Point of Sale display, or POS display. The tablet can be used to provide interactive communication with visitors/customers at the exhibition or shop. In such situations, it is firstly desired to provide a proper stand so that the tablet is held in a position where the visitors/customers can effectively use and view the tablet. Secondly it is desired to ensure that a thief cannot steal the tablet. The tablet holding system should therefore be arranged with some form of locking mechanism to lock the tablet.

Some examples of tablet holding systems are provided in US2012026684 AA, DE202011102783 U1, US2012080577 AA and US2012025035 AA. The prior art solutions however suffer from various drawbacks. For example, some of the prior art tablet holding systems cannot be locked effectively, others cannot pivot and others cannot be connected securely to a charging cable.

### SUMMARY OF THE INVENTION

A first aspect of the current invention is therefore to provide a tablet holding system as mentioned in the introductory paragraph which is better than the solutions provided in the prior art.

This is provided in that the tablet holding system further comprises a connection element which connects the housing to the mounting fixture, said connection element comprising a fastening portion which is insertable into the cylindrical portion of the mounting fixture and fastenable to the inside of the cylindrical portion of the mounting fixture by expanding the fastening portion from the inside of the cylindrical portion of the mounting fixture and in that the housing is fastened to the connection element with a screw which is inserted through the back plate in a direction from the tablet facing side of the back plate towards the fastening portion of the connection element and which is hidden by a tablet when a tablet is locked in the housing.

In this way a secure connection is established between the housing and the mounting fixture which ensures that it is not possible to remove the housing or the tablet from the housing without first opening the locking mechanism and removing the tablet. Therefore, the key in the locking mechanism is required to disassemble the tablet holding system.

In one embodiment, the connection element could be arranged to allow the housing to pivot, but to limit the pivot motion to a motion of less than 360 degrees, less than 180 degrees or equal to 90 degrees. This is advantageous since a charging cable attached to the tablet will not get overtwisted and thereby break. In another embodiment, instead of limiting the motion, stops could be provided which stop the pivot motion when the tablet is at 0 and 90 degrees. This provides an easy way to put the tablet in a landscape or a portrait orientation. The stop elements could be arranged in many different ways, one example being a spring loaded pin which snaps into detentions or recesses.

In one embodiment, the screw which holds the housing onto the fastening portion of the connection element could be arranged within the area defined by the area of the connection element which is in contact with the housing or within the area defined by a cross section through the cylindrical portion of the mounting fixture taken along a plane which is parallel to the housing when the housing is mounted to the fastening portion. In this way the screw cannot be accessed since it is located inside the cylindrical portion of the mounting fixture.

It should be emphasized that the term “comprises/comprising/comprised of” when used in this specification is taken to specify the presence of stated features, integers, steps or components but does not preclude the presence or addition of one or more other features, integers, steps, components or groups thereof. For example in claim 1 it is stated that the housing is fastened to the connection element with a screw. However, this should be read in that the housing is fastened to the connection element with at least one screw.

Furthermore, it should be noted that the claims as currently on file define one scope of protection however, a separate divisional application which focuses on the combination of a tablet holding housing and the pivot fitting disclosed in the current specification could also be filed in the future.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1 shows an exploded perspective view of a first embodiment of a tablet housing system according to the current invention.

FIG. 2 shows a perspective view of the tablet housing system shown in FIG. 1, in a portrait orientation.

FIG. 3 shows a perspective view of the tablet housing system shown in FIG. 1, but pivoted 90 degrees into a landscape orientation.

FIGS. 4a-4c show schematic side views of the assembly of the tablet housing system shown in FIG. 1.

FIG. 5 shows a cross section view through the housing and tablet of the tablet housing system as shown in FIG. 1.

### DETAILED DESCRIPTION OF THE EMBODIMENTS

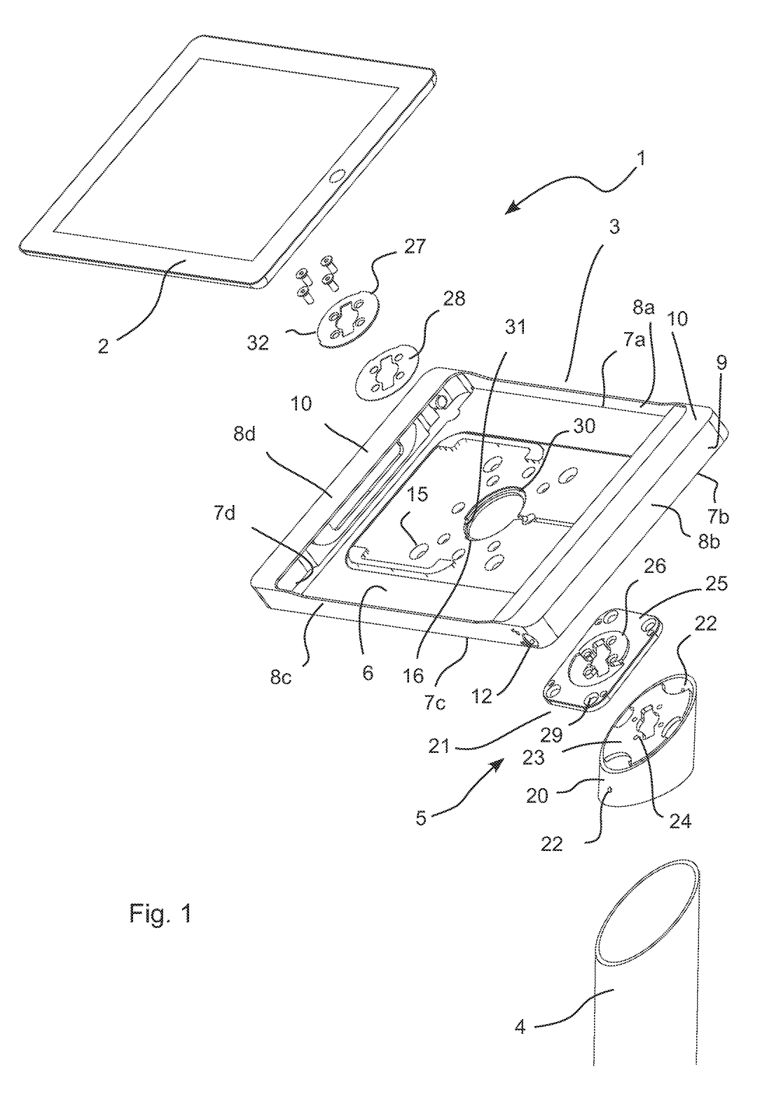

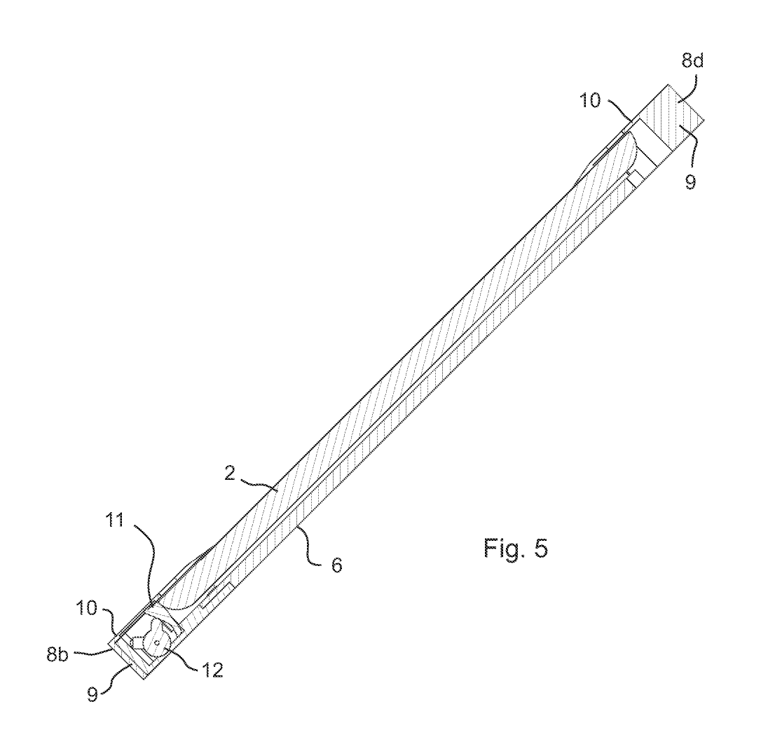

FIGS. 1-5 show different views and orientations of a first embodiment of a tablet holding system according to the invention. It should be noted that the embodiment shown in the figures discloses a number of other inventions which could be the subject of divisional applications.

The embodiment 1 shown in the figures comprises a tablet 2, a housing 3 for holding the tablet, a mounting fixture 4 and a connection element 5 for connecting the housing to the mounting fixture 4. In the current embodiment, the tablet 2 is an iPad™ but it could just as well be another tablet for example a Windows™ or an Android™ tablet. Depending on the type of tablet used, the form of the housing might be different, for example to accommodate different charging connector sizes and locations.

The housing 3 of the current embodiment comprises a rectangular back plate 6 which provides the main support for the tablet 2. On two opposing side edges 7a,7c of the back plate a protrusion 8a,8c is arranged which protrudes perpendicularly from the back plate. The protrusions 8a,8c are arranged to sandwich the tablet between them and prevent the tablet from displacing in a direction parallel to the plane of the back plate and perpendicular to the longitudinal axis of the opposing side edges 7a,7c. On the other two opposing side edges 7b,7d of the back plate 6, a holding flange 8b,8d is arranged. The holding flanges comprise a base portion 9 which extends perpendicularly to the back plate and a cover portion 10 which protrudes from the base portion and covers a part of the tablet. Both the holding flanges and the side protrusions are non displacable in the current embodiment.

In the current embodiment, a displaceable element 11 arranged together with one of the holding flanges 8b, can be displaced towards the opposing holding flange 8d. In a mounting operation, the tablet is first slid under the cover portion 10 of the holding flange 8b which comprises the displaceable element and then set down on the back plate 6. The displaceable element is then displaced towards the opposing holding flange 8d thereby displacing the tablet under the cover portion of the opposing holding flange. In this embodiment, the distance between opposing edges of the cover portions is less than the length dimension of the tablet. Therefore, the tablet can't be removed once the displaceable element has pushed the tablet under the opposing cover portion.

In the current embodiment, the displaceable element 11 is displaced with a key mechanism 12.

It should be noted that many other embodiments of housings could also be used together with the current invention. For example, instead of a solid back plate, a frame could be provided instead. One embodiment of a frame would be an X shaped frame comprising two elements arranged in an X form. Side locking elements and end locking elements could be provided at the ends of the elements of the X-frame which engage with the corners of the tablet.

Furthermore, it should be noted that instead of side protrusions which extend along the entire length of the back plate, point protrusions or other forms of elements preventing sideways motion could be provided. Furthermore, instead of a displaceable element which pushes the tablet under the cover portion, the cover portion or the holding flanges themselves could be displaceable.

In general, the person skilled in the art will be able to provide many different embodiments of housing which are suitable for use with the current invention. Furthermore, the term “back plate” when used in the claims should be interpreted broadly and should not be limited to a solid back plate as shown in the figures, but should encompass all different planar forms which could support a tablet.

Furthermore, a number of different mechanisms for holding the tablet on the back plate would be available to the person skilled in the art. In general terms, the housing will have “holding elements” which can hold the tablet on the back plate by gripping onto the edges of tablet. The housing will furthermore have a locking mechanism which is activated by a key. This should also be interpreted quite broadly. Especially the word “key” should be interpreted broadly enough to include combination locks, fingerprint sensors, keypads, etc.

The back plate of the current embodiment has a number of mounting holes 15. These holes are used if it is desired to mount the housing directly to a standard fitting, for example a VESA, RAM or Vogel fitting. In these situations, the screws are inserted through the back plate and into the standard fitting from the tablet facing side of the back plate. Once the screws are placed in the backplate and screwed into the fitting, then they will be covered by the tablet when the tablet is inserted into the housing. As such, it is not possible to remove the screws without first removing the tablet from the housing.

In the current embodiment, in the centre of the back plate, a larger hole 16 is provided. This hole is used to allow a charging cable (not shown) for the tablet to be brought into the housing. The hole can also be used together with a pivoting connection element 5 as will be described below.

In the current embodiment, the mounting fixture 4 is provided in the form of an elongated circular tube. The tube is of a standard diameter and can be purchased with a length which fits the current task at hand. The tube can also be bent to a desired shape. On the lower end (opposite the housing) the mounting fixture can be provided with a stand or it could be provided with fastening means for fastening it to another structure or foundation. If the tube is large enough, a charger for the tablet can be arranged in the tube itself.

In the current embodiment, the connection element 5 comprises two separate portions, a fastening portion 20 and a pivot portion 21, however in other embodiments the fastening portion and the pivot portion could be combined into one element. The fastening portion 20 is provided as a tubular element which is cut at an angle on one or both sides. In the current embodiment, the fastening portion is cut at a first angle on one side and a second angle on the other side. This allows the same fastening portion to be used to provide two different mounting angles for the housing. The fastening element has two holes 22 in the side of the tubular element through which a screw (not shown) can be inserted. By screwing the screw through one of the holes, the screw can be pressed into the inner side of the tubular portion 4 of the mounting fixture and in this way the fastening element can be “expanded” to press fit itself into the tubular mounting fixture. The fastening portion also comprises an end plate 23 which is welded to the tubular portion of the fastening portion. The end plate 23 comprises holes 24 with internal threads for connecting with screws which hold the housing 3 in place.

The pivot portion 21 comprises a plate element 25 on which is formed a cylindrical protrusion 26 arranged at the centre of the plate element. The cylindrical protrusion fits into the hole 16 in the housing in a rotational fit, such that the housing is prevented from displacing along the plane of the back plate when the housing is mounted on the cylindrical protrusion. However, the housing can pivot about the cylindrical protrusion 26.

In order to prevent the housing from being removed from the cylindrical portion, the pivot portion 21 also comprises a circular locking plate 27 which has a diameter which is slightly larger than the diameter of the hole 16 in the back plate. The locking plate is screwed onto the cylindrical portion and further into the end plate 23 of the fastening portion, thereby sandwiching the housing between the locking plate and the fastening portion of the connection element. A friction reducing element 28 is arranged between the locking plate and the housing in order to reduce friction between the housing and the locking plate during pivot motion.

On the housing along the circumference of the hole in the centre of the back plate on the tablet facing side of the back plate, a groove 30 is machined, thereby expanding the diameter of the hole on the tablet facing side of the back plate. However, the groove does not extend along the entire circumference of the hole, thereby leaving a stop portion 31. The outer diameter of the locking plate 27 is arranged to fit inside the new outer diameter of the groove 30. The locking plate 27 is then placed in the groove and screwed to the cylindrical protrusion. A cutout 32 along the circumference of the locking plate allows the stop portion on the housing to fit into the cutout of the locking ring.

Due to the difference between the sector angle of the cutout 32 in the locking plate 27 and the sector angle of the stop portion 31 of the housing, the housing is able to pivot, but is limited to how much it can pivot. In the current example, the pivot only allows the housing to pivot 90 degrees. This restriction in pivot degrees ensures that the charging cable doesn't break due to over pivoting the housing.

It should be noted that the current embodiment shows a circular locking plate. However, other forms of locking plate could also be imagined. For example a square or rectangular element could be imagined which is arranged to fit inside the groove 30. Or an embodiment could be imagined which did not have a groove in the back plate 6, and where the locking plate was just arranged to be larger than the diameter of the hole in the back plate. Furthermore, in the current embodiment, the stopping mechanism for preventing over rotation of the housing is arranged via cutouts in the locking plate and via stop portions in the groove, however, other embodiments could also be imagined, for example, comprising pins or protrusions arranged on the back plate which interact with the locking plate. Many different embodiments are possible.

It should also be noted that in the current embodiment, the cylindrical protrusion element 26 is fastened to a plate element which is arranged on the side of the back plate which is facing away from the tablet. The housing is first mounted on the cylindrical protrusion after which the locking plate is mounted on the cylindrical protrusion. However another embodiment would be where the locking plate and the cylindrical protrusion were joined together into a single element. The cylindrical protrusion could then be inserted into the hole 16 in the housing from the tablet facing side of the back plate after which the housing could be placed on the fastening portion of the connection element and screwed into place.

It can also be noted that the plate element 25 of the pivot portion 21 of the connection element 5 of the current embodiment comprises holes 29 on the sides of the circular cylindrical protrusion element 26. These holes can be used to mount the plate element 25 directly to another standard fitting. This could be used if the fastening portion 20 of the connection element should not be used. The holes 29 could for example be arranged in a standard VESA pattern which would allow the pivot fitting to be attached to other mounting fixtures which have a VESA hole mounting pattern.

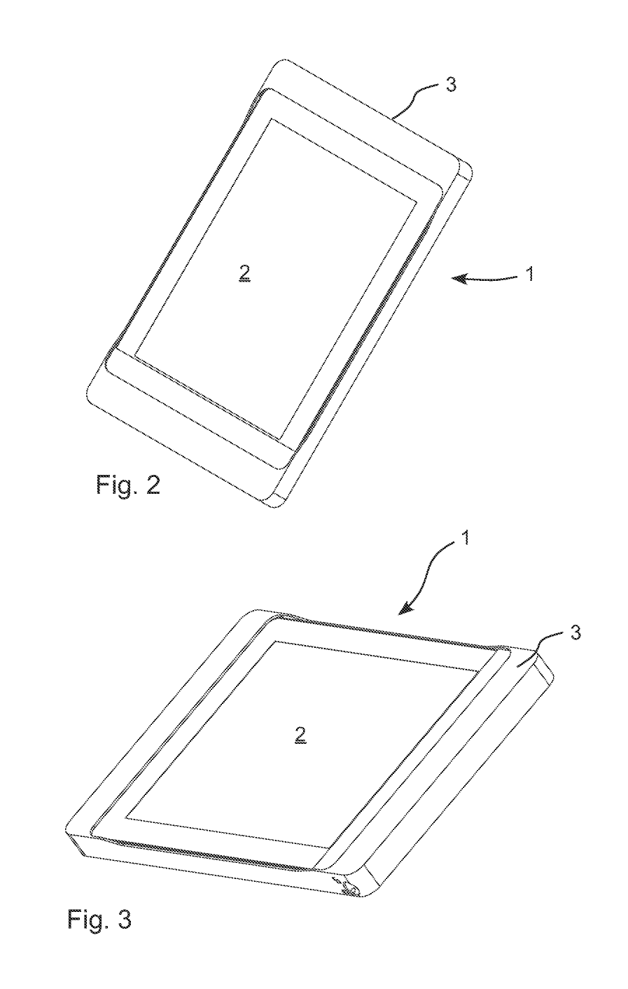

FIGS. 2 and 3 show the housing with a tablet mounted in the housing in the two pivoted positions, first a portrait orientation and then a landscape orientation.

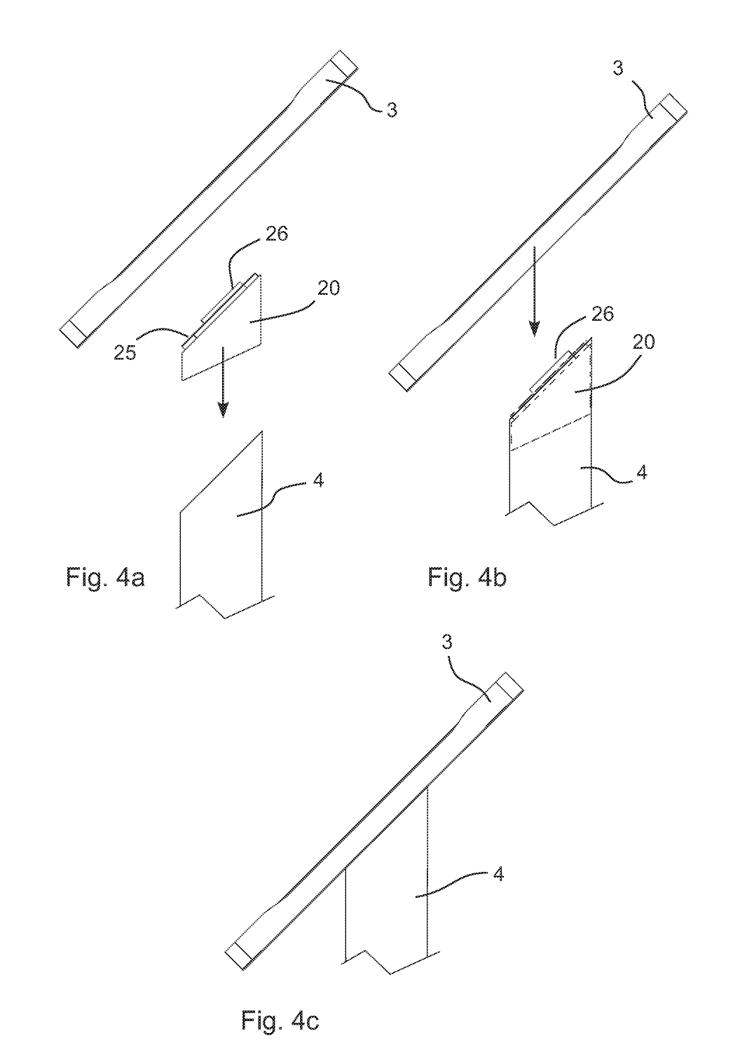

FIGS. 4a-4c show the mounting procedure in more detail. In a first step (FIG. 4a) the connection element 5 is inserted into the cylindrical portion of the mounting fixture 4. In the next step (FIG. 4b), a screw 40 is inserted into the hole 22 of the connection element 5 to fix the connection element in the mounting fixture 4. In the next step (FIG. 4c) the housing is placed on the cylindrical portion 26 of the connection element. Then the locking plate 27 and the friction reducing plate 28 is screwed onto the cylindrical portion 26 thereby fixing the housing to the connection element. The tablet can then be inserted into the housing and the locking mechanism locked to prevent the tablet from being removed from the housing.

1. A tablet holding system (1) comprising:
a. a housing (3) suitable for holding a tablet (2), said housing comprising
i. a back plate (6) which is suitable for supporting a tablet,
ii. holding elements (8a-8d) arranged along the periphery of the back plate which are suitable for holding onto the side edges of a tablet and
iii. a locking mechanism (12) with a key, said locking mechanism arranged to lock the holding elements so that it is not possible to remove a tablet held in the housing when the locking mechanism is activated,
b. a mounting fixture (4) onto which the housing is mountable to support the housing in a desired position or positions, said mounting fixture comprising a cylindrical portion (4),
wherein the tablet holding system further comprises a connection element (5) which connects the housing (3) to the mounting fixture (4), said connection element (5) comprising a fastening portion (20) and wherein the housing is fastened to the connection element with a screw which is inserted through the back plate (6) in a direction from the tablet facing side of the back plate towards the fastening portion (20) of the connection element (5) and which is hidden by a tablet when a tablet is locked in the housing.

2. A tablet holding system (1) according to claim 1, wherein the connection element (5) is arranged to allow the housing to pivot, but is arranged to limit the pivot motion to a motion of less than 360 degrees, less than 180 degrees or equal to 90 degrees.

3. A tablet holding system (1) according to claim 1, wherein the connection element (5) is arranged to provide stopping positions when the housing is at 0 and 90 degrees.

4. A tablet holding system (1) according to claim 1, wherein the housing (3) comprises a circular hole (16) in the base plate (3) and in that the connection element (5) comprises a circular cylindrical disc element (26) which is arranged to fit in the circular hole in the base plate such that the housing can pivot about the cylindrical disc element, but is prevented from displacing with respect to the cylindrical disc element along a plane which is parallel to the base plate, and in that the connection element (5) further comprises a locking plate (27) which has an outer dimension which is larger than the diameter of the hole (16) in the base plate, which is arranged on the tablet facing side of the base plate and which is fastened to the cylindrical disc element (26) with screws from the tablet facing side of the base plate such that the base plate is sandwiched between the locking plate (27) and the fastening portion (20) of the connection element (5).

5. A tablet holding system (1) according to claim 4, wherein the connection element (5) further comprises a friction reducing element (28) which is placed between the locking plate (27) and the housing (3) in order to reduce the friction between the housing and the locking plate during pivoting of the housing.

6. A tablet holding system (1) according to claim 1, wherein the screw which holds the housing (3) onto the fastening portion (20) of the connection element (5) is arranged within the area defined by the area of the connection element (5) which is in contact with the housing or within the area defined by a cross section through the cylindrical portion (4) of the mounting fixture taken along a plane which is parallel to the housing (3) when the housing (3) is mounted to the fastening portion (20).

7. A tablet holding system (1) according to claim 4 wherein the housing (3) comprises a groove (30) arranged along the periphery of the circular hole (16) in the base plate (6), said groove being arranged on the tablet facing side of the base plate such that the locking plate (27) can be arranged in the groove.

8. A tablet holding system (1) according to claim 7, wherein stop elements (31) fastened to the housing (3) are arranged in the groove (30) and in that the locking plate (27) is provided with cutouts (32) along its periphery which interact with the stop elements to limit the angular motion of the housing with respect to the connection element (5).

9. A tablet holding system (1) according to claim 1, wherein the back plate (6) and/or the locking plate (27) comprise a hole (16) through which a charging cable for the tablet can be routed.

10. A tablet holding system (1) according to claim 1, wherein the cylindrical portion (4) of the mounting fixture is arranged to allow a standard charger from a tablet to fit inside the cylindrical portion.
